(19) United States
(12) Patent Application Publication
(10) Pub. No.: US 2012/0234826 A1
(43) Pub. Date: Sep. 20, 2012

(54) CONTINUING TIMER FOR MICROWAVES AND RANGES

(75) Inventor: Dimitrios Iordanoglou, Louisville, KY (US)

(73) Assignee: General ELectric Company

(21) Appl. No.: 13/048,320

(22) Filed: Mar. 15, 2011

(51) Int. Cl. H05B 6/68; H05B 6/64

(52) U.S. Cl. 219/680; 219/719

(57) ABSTRACT

Apparatus and methods are disclosed for an oven timer of microwave ovens or hybrid ranges. The timer counts down to a zero time according to a programmed time entered at a control panel. The timer counts up for a cooling time that may be programmed for a precise cooling time or continue until a stop input is received when retrieving the item being cooked.

### BACKGROUND

The subject disclosure relates generally to cooking appliances, and more particularly to features built within cooking appliances to enhance the cooking experience.

Cooking a meal, such as a delicacy item or other food item, includes a set temperature that is provided for a certain time and with a certain amount of heat to ensure proper texture, richness and built-in flavor for an optimal experience. Appliances can vary for use in the culinary arts and provide for different benefits associated with each of them. For example, microwaves can provide for heating items quickly, such as for a quick buttery sauce or warming dishes. A gas grille can provide taste and texture not provided by other cooking devices. In addition, perfecting each dish and the mixture of ingredients with seasonings can be as much a repeatable science as an expression of the person. For example, while one region of a country desires hot curry, another region desires mild. While one region desires dill, another desires sweetness. Countless number of examples can delineate the differences among taste, the genetics involved or the tie to a climate among global regions. Different appliances allow for different cooking methods as well. While a person can leave a microwave after setting the timer, a person cannot leave a grille as long without burning the food cooking.

One problem with a microwave is tied to the benefit of the device. Being able to leave a microwave with a set timer allows for an effective and safe use of time, without having to monitor the food closely. However, a problem arises when optimal cooking time for a dish or delicacy item is unknown or a person becomes distracted, as may occur with new or different cuisines being cooked at once for different dishes. In particular, a person may leave the microwave after setting the timer and beginning the cooking process, become involved with something else in a busy kitchen, and not hear that the microwave has finished. As a result, the food may cool or fail to be sampled for completion of the cooking process. Thus, a need arises to better assist the cook when using microwave type energies that end immediately after a programmed time completes.

### BRIEF DESCRIPTION OF THE DISCLOSURE

According to one aspect, a cooking appliance comprises a cooking cavity for heating an item therein and a source of energy for heating items in the cooking cavity. A control panel comprises a user actuable interface for inputting cooking instructions including the desired cooking time and a display. A controller is coupled to the control panel and the source of energy and is operative to control the amount of heat and the duration of the heating cycle according to cooking instructions received at the user interface. A timer is coupled to the controller and configured to count down from the desired cooking time to a zero time and count up from the zero time when the zero time is reached. The controller is operative to end the heating cycle upon the timer counting down to zero. The count of the timer represents the remaining cooking time when counting down and the elapsed cooling time since the end of the heating cycle when counting up.

According to another aspect, a method for operating an oven having a controller and a memory for executing the method is disclosed. Upon initiating a programmed time from a timer received at a panel of the oven, the oven is energized to provide radiation into a heating cavity for cooking an item. A count-down from the programmed time to a zero time is displayed according to a timer while the magnetron provides radiation into the heating cavity for cooking the item. Upon a timer reaching a zero time to complete the count-down, a first count-up to a first cooling time is displayed without energizing the magnetron for a cooling time. A total time is displayed that includes the first cooling time and the first programmed time upon receiving a total time display input. The count up continues until a stop input is received to stop the count up of the timer, which determines the cooling time that the oven has not been energized with the item in the heating cavity.

Still other features and benefits of the present disclosure will become apparent from reading and understanding the following detailed description.

### BRIEF DESCRIPTION OF THE DRAWINGS

Reference is now made briefly to the accompanying drawings, in which:

FIG. 1 is a perspective schematic view of a microwave cooking appliance such as a microwave oven in which is implemented an exemplary embodiment of a timer;

FIG. 2 is a schematic functional block diagram of a hybrid microwave cooking appliance in which an exemplary embodiment of a timer is implemented; and

FIG. 3 is a process flow of an exemplary aspect of a timer in microwave or hybrid oven.

Like reference characters designate identical or corresponding components and units throughout the several views, which are not to scale unless otherwise indicated.

### DETAILED DESCRIPTION

Appliances, such as microwave ovens, hybrid microwave ovens and convection ovens utilizing microwave energy and/or conventional heat sources are implemented with concepts illustrated and detailed herein. The appliances have a controller with a timer that is provided for heating items at various degrees and times. The timer includes a count-up timer that indicates how much time has passed since a count-down has terminated. The timer is coupled to a control panel having a timer that receives programmed options and a display in the panel that indicates different times. For example, the display provides a total time since countdown, a countdown time, a clock time, a total cook time, a total overtime and/or other such times. The different times are displayed when desired by a user and an input is received at the panel. This combination of features enables a consumer to know the precise cooking and delay times for cooking various dishes, to explore different cooking options, and allow for more timely custom cooked meals, which is further described in detail below.

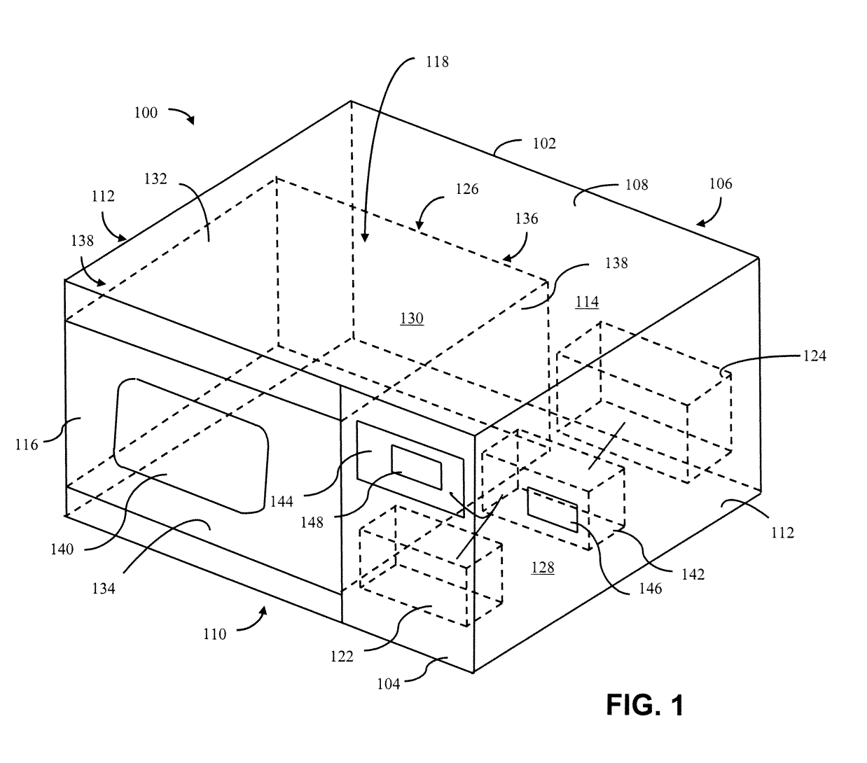

FIG. 1 illustrates an aspect of an exemplary embodiment for a timer in an oven 100, which is a microwave oven. However, the timer discussed herein is not limited to microwave oven applications, but also can be used in hybrid microwave ovens, traditional convection ovens, and the like.

The oven 100 includes an outer housing 102 generally configured to permit placement of the oven 100 on a counter or secured to kitchen cabinetry or a kitchen wall. The outer housing 102 is configured with a front panel 104, a rear wall 106, a top wall 108, a bottom wall 110, and pair of opposed side walls 112. Combined together the walls of the outer housing 102 form an interior cabinet 114 which encloses a component compartment 128 and a cooking compartment 118. Cooking compartment 118 comprises an oven cavity 126 defines an interior space 130 for receiving items to be heated. Cavity 126 comprises a top cavity wall 132, a bottom cavity wall 134, a rear cavity wall 136, a pair of opposed side cavity walls 138 and a front cavity wall formed by access door 116. Component compartment 128, houses components including a power supply 122, a RF generation module in the form of magnetron 124 and a controller 142.

The door 116 comprises a door frame (not shown), a grille (not shown) and a window 140 located in the door for viewing food in the oven cooking cavity 126. The oven 100 has a controller 142 that is operatively associated with power consuming feature/functions of the oven 100. The controller 142 can include a micro computer on a printed circuit board, which is programmed to selectively control the energization of the power consuming feature/functions. The oven 100 has a control panel 144 configured with a conventional user interface (not shown) for operating the oven 100. For example, the user interface can include buttons, touch screen controls, menus, a graphical user interface, voice controlled interface controls and the like for receiving control instructions for cooking and other oven features, and a display 148 that displays operational information including timer sequences to the user. Panel 144 is communicatively linked to the controller 142 for sending user input information to controller 142 and receiving display information, including time information from controller 142.

In one embodiment, the controller 142 includes a timer 146 that presents time related timing sequences at the control panel display 148 of the microwave 100. The timer 146 is configured, for example, to selectively display a time within the display 148 in response to user inputs at the control panel 144. The timer 146 is operative to receive a control signal for providing a timed sequence, such as a programmed time for cooking during which the controller 142 is operative to control energization of the magnetron 124 to provide the desired power level for the specified cook time. The timer 146 is housed within the oven 100, but may also be external to the oven and used to operate more than one oven appliance. The timer 146 counts down in a count-down sequence for a programmed time for cooking and once the programmed time reaches a zero time, the timer 146 continues counting but in the reverse direction in a count-up sequence until a stop input is received such as an appropriate input via control panel 144 or by opening the oven door, e.g., to remove an item from the oven, or both. Opening the door actuates a door switch that is communicatively linked to controller 142. Actuation of the door switch is recognized by controller 142 as a stop signal. During the count-up sequence, the timer 146 operates without the magnetron 124 or any heating source being activated for cooking, and therefore, a cooling time occurs for the amount of time that the timer counts upward until a stop input is received. A user may input at the panel 144 a stop input, for example, that stops the count-up sequence of the timer 146, which is displayed on the display 148. The timer 146 is continuous, and thus, does not stop counting up until a user provides a stop signal. By this arrangement, the display indicates how much time has elapsed since the end of the heating cycle for the item in the oven. One advantage of knowing the cool time that has elapsed is provided when the item in the oven is not finished cooking and the user has to re-program the oven again to further cook it, which may occur due to oven variations in manufacturing, for example. Once the item is finished to the user's satisfaction, the user can take into account the amount of the time the food cooled in between cooking times for programming the oven in the future for the same item. For example, a burrito may have cooled for five minutes after cooking for two minutes and then further re-heated for one minute. Knowledge of the cooling time provides the user the means to subtract the cool time (e.g., two minutes for the burrito), and gauge how much more or less may be required to cook the item in the future for an optimal temperature with the particular oven.

In other embodiments, the display 148 flashes and/or provides sound signals (e.g., beeping sounds or the like) in order to notify the user of the oven that the programmed time for cooking an item has completed and the timer is counting upward. This notifies the operator or user of the oven that a count-up or cooling time has initiated since a zero time in the count-down was reached and a cooking time was completed as programmed. Alternatively in another embodiment, a cool time may be programmed. In some case microwave foods instruct or provide directions for a cool time after cooking for a certain period. For example, a frozen burrito may have instructions under the microwave directions to cook on high for one minute, stop flip over, cook for another minute, and then let cool for two minutes thereafter. Therefore, the count-up sequence can be pre-programmed for this purpose, in which case a stop input will be generated by the controller when the pre-determined cool time has elapsed. A first programmed time may be initiated and a first count-up time for cooling afterwards may both be programmed. Then, a second programmed cook time may initiate as programmed for cooking a second time. After cooking for a second cook time, the panel 144 may display the count-up time, which may flash and/or beep to notify the user that cooling has initiated and cooking within the oven is complete. The present disclosure is not limited to any number of sequences with a cook time and a cool time. If no cool time is pre-programmed, the timer initiates a count-up time that signifies an amount of cooling time after cooking that is occurring until a stop input is received.

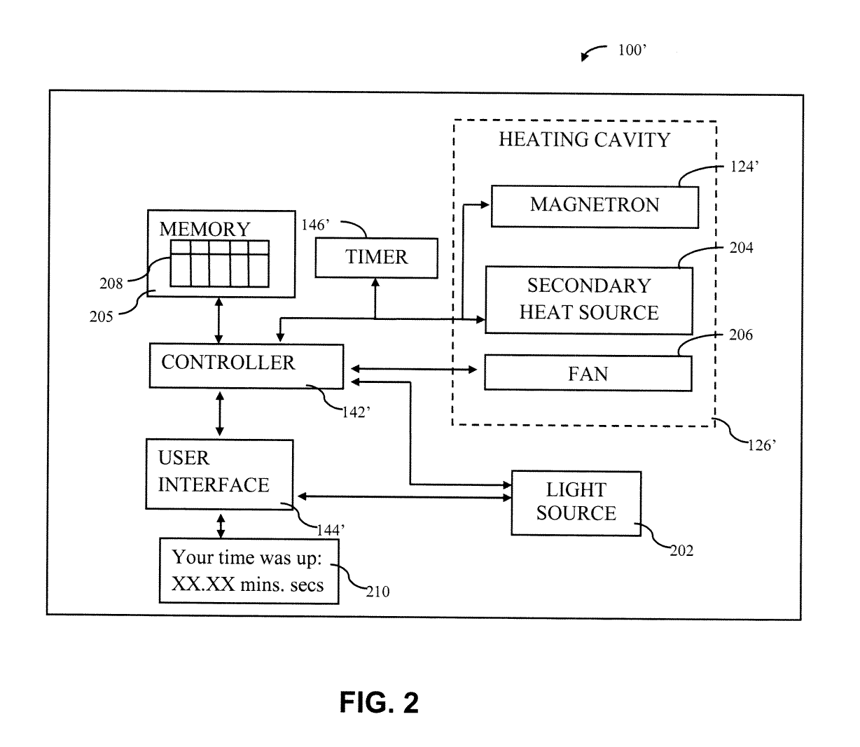

FIG. 2 illustrates aspects of exemplary embodiments of an oven 100′ that is a hybrid oven having microwave components and conventional oven components, for example. Other ovens are also envisioned and the present embodiments are not limited to any one particular type of oven. The oven 100′ has a timer 146′ coupled to a controller 142′, for example. The controller 146′ is coupled to a memory 205 for storing instructions 208. The controller 146′ executes the instructions 208 that are received at the user interface 144′ (e.g., control panel) of the oven. Like the previously describe interface 144, interface 144′ may be configured with different known input arrangements for programming the oven 100′. For example, the user interface can include buttons, touch screen controls, menus, a graphical user interface, voice controlled interface controls and the like for programming cooking, lighting and/or timer instructions thereat.

The oven 100′ is illustrated as a hybrid oven having different heat sources that are operable with the programming instructions 208 executed by the controller 142′. The oven 100′ includes a heating cavity 126′ with a magnetron that is operative to heat food or other items placed within the cavity 126′ via microwave energy. The oven 100′ further includes a secondary heat source 204 that heats items within the cavity together with the magnetron 124′ or at a different time period. The secondary heat source 204′ may be a light bulb, a broil element, a coil around a fan 206 similar to a true convection oven or other supplemental heating device. In alternative embodiments, the secondary heat source 204 is the only source of heat and the oven 100′ may not include a magnetron 124′ for microwave energies to be generated, as with traditional ranges. In FIG. 2 the magnetron can be mounted to a magnetron mount on a surface of the cavity. The oven may further include the fan 206 for cooling the magnetron and/or a light source 202 for illuminating the cavity 126′. A separate light source 202 can be provided for illuminating a top cooking surface of a range where the oven 100′ operates as an over the range microwave, for example.

The oven 100′ further includes a display 210 that is operatively coupled to the timer 146′ and a user interface 144′ having controls thereat for making various operational selections, such as an oven control panel. Cooking algorithms can be preprogrammed in the oven memory 205 for many different types of foods, for example. When a user is cooking a particular food item for which there is a preprogrammed cooking algorithm, the preprogrammed cooking algorithm is selected by actuating one of the user interface controls. Instructions, selections and various times are displayed on the display 210. A light source may also be provided for illuminating the display panel.

In one embodiment, the timer 146′ is operatively coupled to the controller 142′ to count down during a cook cycle according to the optimal time, instructions from a recipe or directions on the back of a frozen food for heating. The cook cycle, for example, may be for three minutes for a microwave at full power, and thus, the user interface 144′ receives programming instructions for the controller 142′ to allow power to the magnetron 124′ for microwave generation for three minutes. The timer 146′ counts a count-down sequence for the programmed time until the count-down is finished and a zero time is reached.

After the count-down sequence is terminated, the timer 146′ is configured to generate a count-up sequence that is a cool down period in which no heat source is powered to provide heat energy into the cavity 126′. For example, a count-up sequence can be generated at the display 210 as illustrated by the words “Your time was up: XX.XX mins. secs.” The count up sequence is displayed after a cooking cycle for the oven is terminated to zero time and is displayed in the display in order to provide indication to the user the length of time in which the item has remained after completion of the cooking cycle. In certain embodiments, the display 210 and the timer 146′ are configured to beep during the count-up sequence in order to alert a user of the oven that the programmed cook time has completed and the oven is no longer cooking. Further, the count-up sequence is provided in the display 210 of the timer 146′ and is made to flash periodically. This further alerts a user of the finished count-down time of the cooking cycle by drawing attention to a continued beeping and/or flashing display, for example. After removing the cooked items, the user of the oven 100′ will have an idea of how long the food has been cooked and cooled.

An advantage of such a count-up sequence is that some cooking directions call for a cool down time and a user does not have to manually program a further count-down sequence to determine the amount of time an item has been cooled. The oven timer 146′ immediately counts-up until receiving a stop input, such as a stop button control at the interface panel of the oven 100′ or other like input. A count-up feature allows a consumer or user of the oven 100′ to know exactly how much time has passed beyond the originally programmed count-down sequence for cooking an item in the cavity 126′.

The timer 146′ is adaptive to provide for a total cook time that is repeatable by a user, as well as a total cool time, or a total time including the cook time and cool time. For example, when cooking items from a cookbook, recommendations may be provided for a cooking or baking time. Due to oven variations, a user may have to cook over or under the time recommended. After multiple adjustments of resetting the time to energize the magnetron 124′, for example, or other heating source, the optimal cooking time for the particular recipe may not be remembered to repeat the result. At the end of the preparation, a total time is provided to the user of the cooking time and cooling time in order for the user to know exactly how long to cook a dish with the particular oven used.

In other embodiments, a user of the oven may wish to cook an item using one heating source and then switch to another heating source that either replaces or supplements the first heating source being used. For example, in a hybrid oven a first heating source may provide microwave radiation, such as the magnetron 124′ or other heat source, and the second heat source 204′ may be used. In this case, the timer 146′ initiates a first count-down time and then a second count-down time, which respectively correspond to the amount of time different heating methods are provided to the item in the heating cavity.

In one example, the timer 146′ provides a first count-up sequence after the first count-down sequence and provides a second count-up sequence that continues until it is stopped, which begins after a second count-down time. Any number of count-up and count-down sequences can be envisioned herein and the present disclosure is not limited to any number.

An advantage of having different cook times and different cool times is not limited to just programming different heat sources. With a single heat source oven, such as a standard microwave oven, a user of the oven may wish to program a count-down for providing heat to an item, and intentionally want the item to cool for a period of time until heating the item further at a different second programmed count-down sequence. In this case, a second count-up sequence is provided that is continuous after a second programmed cook time has terminated. The display 210 continues to provide the total amount of time that the item has been in the microwave since being cooked, the total amount of cook time and/or a total amount of cool time.

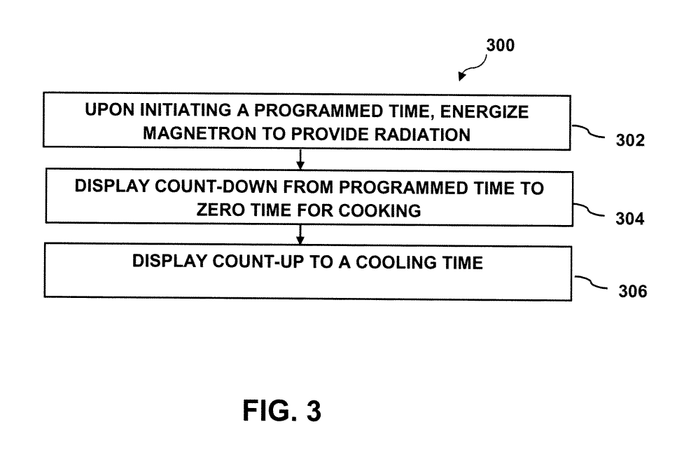

Example methodology 300 for operating an oven having a controller and a memory for executing the method is illustrated in FIG. 3. While the method is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At 302, the method 300 begins upon initiating a programmed time at the timer 146, 146′. The controller 142, 142′ of the oven signals a heating source, such as a magnetron 124, 124′ or other source to energize and provide heat to a heat cavity 126, 126′ for the heating of an item, such as a food item during a count-down of the programmed time.

At 304, the timer 146, 146′ counts down and a display displays the time sequence from the programmed time for cooking the item until the sequence is finished and a zero time is reached.

At 306, the timer 146, 146′ counts up to a cooling time. The cooling time is the time in which a stop input is received to stop the timer from counting up, for example. The cooling time is a real time that is displayed in the display 210 until a stop input is received. The total cooling time is therefore determined once the count-up sequence is halted. This is the total amount of time in which an item that has been heated has cooled or not been heated within the heating cavity. The stop input may be a button and/or switch that are triggered at a control panel or other type of control for the oven, such as a user opening a door or retrieving the item being cooked. A total time is displayed when a control input is provided and displayed on the display, which includes the programmed time or amount of time the item has been cooked and the cooling time. The user of the oven therefore selects a desired display by appropriate user interface input selection at the control panel for viewing the total time, cooling time, and other times described herein.

In one embodiment, the display sounds an alert during the count-up sequence in order to alert a user that an item that has been cooked is now cooling. Further, the display flashes to further indicate the same. In other certain embodiments, the cooling time may be programmed in order to intentionally cool the item that is heated. Further, a second cook time could be implemented to cook the item after a first count-up sequence that provides cooling in between different cooking times. The second programmed time may be different from the total cooling time reached and start at a different time for beginning a second count-down. As such, the second cooking time does not necessarily count back down from the time the cooling time ends, but initiates with a separately programmed time, which, although not necessary, may be the same amount as the cooling time allowed. This may be for heating an item with a different heat source or be for providing a pause in between cooking for heat distributions to be obtained or different items to be added at different times, such as flipping an item over or adding cheese to be lightly cooked on top of an item already heated within, for example. After additional cooking times are implemented for different count-downs displayed at the timer, a continuous, second count-up sequence initiates to provide an amount of time to the user in which items within the oven have not been heated. In other words, the second count-up sequence operates as a final and continuous count-up time after all cooking has terminated so that a user is alerted of the time that the food has cooled before consumption or serving.

In view of the forgoing discussion, while the concepts of a timer have been presented in connection with ovens (e.g., the oven 100 and 100′), implementation of these concepts can extend to other appliances. Stoves, ranges, ovens, and other devices, which may be outfitted with heating elements such as magnetrons to facilitate cooking and preparation of food. Timer sequences and display modes addressed by the timer of the present disclosure can be implemented as part of the design and integration of such radiative elements.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A cooking appliance, comprising:
a cooking cavity for heating an item therein;
a source of energy for heating items in the cooking cavity;
a control panel comprising a user actuable interface for inputting cooking instructions including the desired cooking time and a display;
a controller that is coupled to the control panel and the source of energy and operative to control the amount of heat and the duration of the heating cycle according to cooking instructions received at the user interface;
a timer coupled to the controller and configured to count down from the desired cooking time to a zero time and count up from the zero time when the zero time is reached the controller being operative to end the heating cycle upon the timer counting down to zero;
whereby, the count of the timer represents the remaining cooking time when counting down and the elapsed cooling time since the end of the heating cycle when counting up.

2. The appliance of claim 1, wherein the timer continues to count up until a stop input is received by the controller

3. The appliance of claim 2, wherein the panel is adapted to selectively display the remaining cooking time, the cooling time and the total time in the display.

4. The appliance of claim 1, wherein the panel flashes the display while the timer is counting up.

5. The appliance of claim 1, wherein the panel provides a sound signal while the timer is counting up.

6. The appliance of claim 1, wherein the panel receives the stop input and is configured to provide a total cook time of the item that includes a first cook time and any additional cook time for the item after the cooling time.

7. The appliance of claim 1, wherein the appliance includes a microwave heating source or a microwave heating source and a non-microwave heating source.

8. The appliance of claim 2, wherein the timer is a continuous timer that is adapted to display a count-down and a count-up time continuously without interruption upon receiving an initiation input and until receiving the stop input, wherein the appliance comprises a microwave oven having a magnetron for providing radiation within the heated cavity.

9. An oven, comprising:
a cooking cavity;
an energy generation module configured to deliver microwave energy into the cooking cavity;
a timer that is configured to provide a count down from a programmed time to a zero time for cooking and a count-up to a cooling time starting at the zero time, wherein the timer is configured to count up until a stop input is received at the controller;
a controller that is coupled to the timer and controls the RF generation module according to cooking instructions received at a panel having a display; and
a power source operatively associated with the controller and the energy generation module, the power source is configured to receive a signal from the controller and transmit the signal to the energy generation module to cause the oven to have microwave energy in the cooking cavity during the count-down of the timer and to not have microwave energy during the count-up,
wherein the display displays the count-down from the programmed time and the count-up for a cooling time.

10. The oven of claim 9, wherein the timer is operative to display the programmed time including a first count-down time and at least one second count-down time.

11. The oven of claim 10, wherein timer displays at least one first count-up time after the first count-down time and a second count-up time subsequent to the at least one second count-down time.

12. The oven of claim 11, wherein the at least one second count-down time initiates at a different time than the first count-up time based on instructions received for cooking at the panel.

13. The oven of claim 12, wherein the oven generates a sound during the count-up of the timer.

14. The oven of claim 13, wherein the timer is displayed in the display and flashes during the count-up.

15. The oven of claim 12, wherein the display displays a total cook time during the first and/or the at least one second count-down, and a total cool time during the first count-up time and/or the at least one second count-up time depending upon a display input received at the panel.

16. A method for operating an oven having a controller and a memory for executing method, comprising:
upon initiating a programmed time received at a panel of the oven, energizing a magnetron to provide radiation into a heating cavity for cooking an item;
displaying a count-down from the programmed time to a zero time while the magnetron provides radiation into the heating cavity for cooking the item;
upon a timer reaching a zero time to complete the count-down, displaying a first count-up to a first cooling time without energizing the magnetron; and
displaying a total time that includes the first cooling time and the first programmed time upon receiving a total time display input;
wherein the count up continues until a stop input is received to stop the count up and determine the cooling time in which the magnetron has not been energized with the item in the heating cavity.

17. The method of claim 16, further comprising:
providing an alert signal from the oven to indicate that the countdown is completed and the zero time is reached, wherein the alert signal includes a sound and/or a flashing signal at the display.

18. The method of claim 16, further comprising:
after reaching the cooling time, energizing the magnetron to provide radiation into a heating cavity for cooking the item during a second programmed time, wherein the cooling time and the programmed time is preprogrammed at the panel.

19. The method of claim 18, further comprising:
after the second programmed time is completed, displaying a second count-up to a second cooling time that is determined when a stop input is received that causes the second count-up to terminate.

20. The method of claim 18, wherein the stop input is received at the oven from a user retrieving the item.
